(19) United States
(12) Patent Application Publication
(10) Pub. No.: US 2013/0175890 A1
(43) Pub. Date: Jul. 11, 2013

(54) Magnetic Energy Cone

(71) Applicant: Rusty Atwood, Bedford, IN (US)

(72) Inventor: Rusty Atwood, Bedford, IN (US)

(21) Appl. No.: 13/735,639

(22) Filed: Jan. 7, 2013

Related U.S. Application Data
(60) Provisional application No. 61/585,363, filed on Jan. 11, 2012.

(51) Int. Cl. H02K 57/00

(52) U.S. Cl. CPC H02K 57/006
USPC 310/46

(57) ABSTRACT

An apparatus for converting magnetic force into electricity is disclosed. The apparatus comprises a base component housing a generator capable of producing enough electricity to power an electric motor. The rotational component is driven by oppositely charged magnets which rotate a shaft connected to the generator to produce electricity.

### CROSS-REFERENCE

This application claims priority from Provisional Patent Application Ser. No. 61/585,363 filed Jan. 11, 2012.

### FIELD OF THE INVENTION

This invention pertains generally to an apparatus for converting magnetic force into electricity, and more particularly to an apparatus for producing a magnetic force to turn a generator capable of producing enough electricity to power an electric motor.

### BACKGROUND

Electric motors found in a wide variety of home, commercial, and industrial applications require a source of electricity to run. Generators are commonly used to power such devices. These generators may be found in large utility plants that are connected to the electrical grid, or may be much smaller home versions such as a small gas powered generator. However, most traditional means of producing electricity such as coal fired plants and nuclear reactors create hazardous by-products that are harmful to the environment. Even small gas powered home generators produce pollutants such as carbon monoxide. More environmentally-friendly options such as wind, solar or water power exist, but are not always accessible or reliable.

Consequently, there is a need for a dependable solution to safely supply clean electrical energy for use to run a motor at any time required. The present invention discloses an apparatus for using a magnetic force to power a generator capable of producing electricity. The apparatus uses a magnetic force to produce motion, which is then converted into electrical energy via a generator. The invention allows a user to produce the electricity to run a motor without reliance on the existing electrical power grid and without specialized knowledge.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an apparatus for converting magnetic force into electricity for running a motor. The magnetic motion apparatus comprises a rotational component movably connected to a base component housing a generator. The base component comprises a conically shaped housing and a stationary magnet surrounding the conically shaped housing. The rotational component comprises a first and a second arm each comprising a rotational magnet distal to an apex. The generator is connected to the rotational component at the apex.

Furthermore, in a preferred embodiment of the invention, the rotational magnets have an opposite magnetic orientation to a magnetic orientation of the stationary magnet. The rotational magnets are tapered so that a first side of the rotational magnets are closer to the stationary magnet than a second side of the rotational magnets so that the first and the second arms rotate about the conically shaped housing when in an engaged position near the stationary magnet. The apex comprises a hinge element so that the rotation of the first and the second arms slows as the hinge element is spread apart moving the first and the second arms away from the conically shaped housing.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of a magnetic motion apparatus in accordance with the disclosed architecture.

FIG. 2 illustrates a cutaway view of the magnetic motion apparatus in accordance with the disclosed architecture.

FIG. 3 illustrates the magnetic motion apparatus in an operating position in accordance with the disclosed architecture.

FIG. 4 illustrates the magnetic motion apparatus in a stopped position in accordance with the disclosed architecture.

FIG. 5 illustrates the magnetic motion apparatus powering a lamp in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

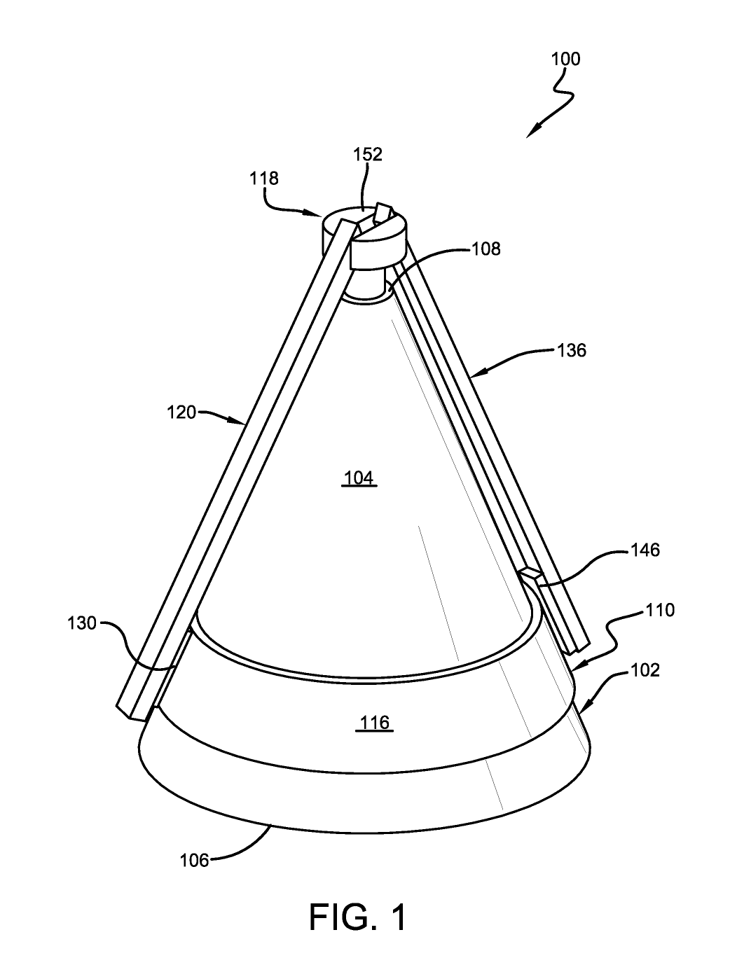

Referring initially to the drawings, FIG. 1 illustrates a magnetic motion apparatus 100 for producing an electric current. The magnetic motion apparatus 100 comprises a base component 102 and a rotational component 118. The base component 102 comprises a conical housing 104 which is typically a substantially hollow aluminum shell, although any other suitable durable material such as composite materials, plastics, and the like, as is known in the art may be used without affecting the overall scope of the invention. In a preferred embodiment of the magnetic motion apparatus 100 suitable for powering a household electrical appliance such as a lamp, the conical housing 104 may measure approximately eight inches in width at a base 106 and approximately eight inches in height from the base 106 to a tip 108. However, the conical housing 114 may be dimensioned smaller or larger as desired to generate larger or smaller amounts of electricity as desired.

The base component 102 further comprises a stationary magnet 110. The stationary magnet 110 is typically a magnetic ring 116 approximately between one and three inches in height, and having an inside diameter ranging from approximately six to seven inches, and a thickness of approximately ½ inches. However, as with the conical housing 104, the magnetic ring 116 may be dimensioned smaller or larger as desired to correspond to the dimensions of the conical housing 104. Additionally, the magnetic ring 116 is typically a single magnet tapered so that it rests substantially flush with or parallel to an exterior of the conical housing 104. The magnetic ring 116 may be lightly glued to the conical housing 104 as desired. Preferably the stationary magnet 110 completely encircles the conical housing 104 approximately one inch above the level of the base 106. The stationary magnet 110 is orientated so that a top 112 of the stationary magnet 110 is positively charged and a bottom 114 of the stationary magnet 110 is negatively charged in a first magnetic orientation thereby providing a constant upward magnetic force.

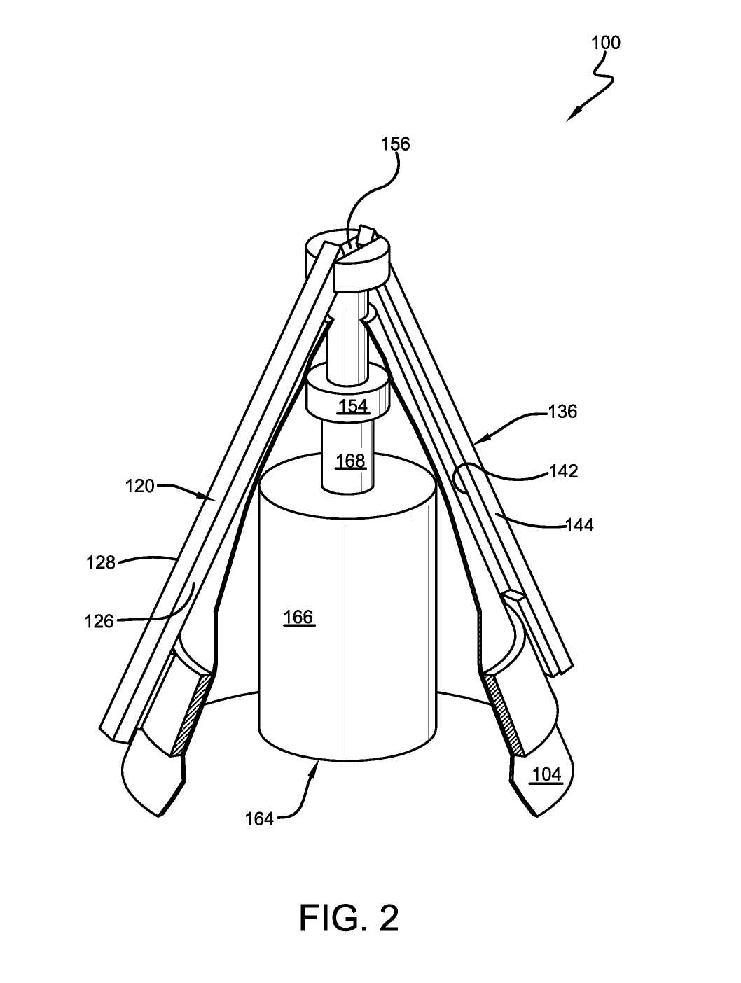

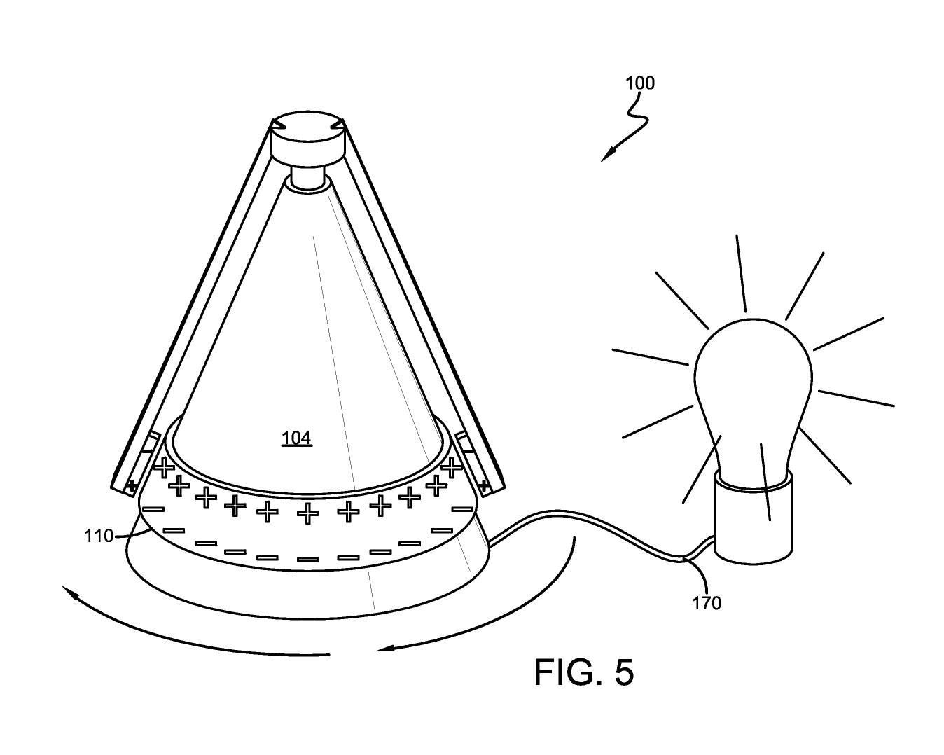

As illustrated in FIG. 2, the magnetic motion apparatus 100 further comprises a generator component 164 housed substantially within the conical housing 104. The generator component 164 comprises a generator 166 and a shaft 168 extending upward out of the generator 166. The generator 166 is powered by the rotation of the shaft 168. The shaft 168 extends up through the tip 108 of the conical housing 104 and connects to the rotational component 118 as described infra. Additionally, the magnetic motion apparatus 100 further comprises an electrical cord 170. The electrical cord 170 is in electrical communication with the generator 166 and may be used to transmit the generated electricity to an electric motor or appliance as illustrated in FIG. 5.

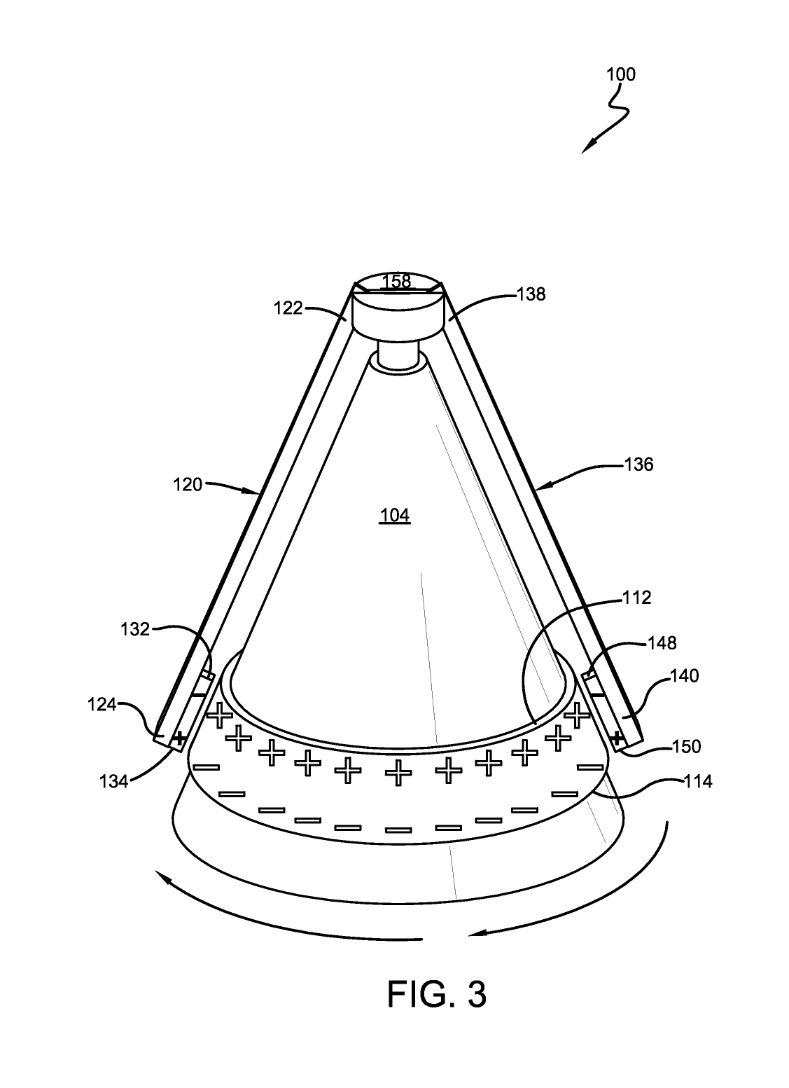

As illustrated in FIG. 3, the rotational component 118 is located exterior to the conical housing 104 and comprises a first arm 120 and a second arm 136. The first arm 120 and the second arm 136 are connected at an apex 152 of the rotational component 118. The first arm 120 and the second arm 136 are typically aluminum, but may also be constructed from any material similar to that of the conical housing 104 as discussed supra. The first arm 120 and the second arm 136 are generally approximately between 10 and 13 inches in length, or otherwise dimensioned to fit a larger or smaller magnetic motion apparatus 100, and extend downward from the apex at an approximately 55 degree angle from the shaft 166 running substantially perpendicularly to the exterior of the conical housing 104.

Both the first arm 120 and the second arm 136 each comprise a proximal end 122 and 138, a distal end 124 and 140, a first side 124 and 142, and a second side 126 and 144. The proximal ends 122 and 138 are angled to fit together at the apex 152. The first arm 120 further comprises a first rotational magnet 130 and the second arm 136 further comprises a second rotational magnet 146. The first and the second rotational magnets 130 and 146 are attached to the first and the second arms 120 and 136 distal to the apex 152 toward the distal ends 124 and 140 of the first and the second arms 120 and 136.

The first and the second rotational magnets 130 and 146 are located approximately equidistant from each other around the conical housing 104. The first and the second rotational magnets 130 and 146 are positioned on the first and the second arms 120 and 136 so that the first and the second rotational magnets 130 and 146 are substantially parallel to and adjacent to the stationary magnet 110. However, first and the second rotational magnets 130 and 146 are also angled approximately 55 degrees downward. Additionally, when in position, the first and the second rotational magnets 130 and 146 may range in distance from the stationary magnet 110 approximately 1/16 inches at the first sides 126 and 142 to approximately ¼ inches at the second sides 128 and 144 of the first and the second rotational magnets 130 and 146.

Additionally, the first and the second rotational magnets 130 and 146 each comprise a top 132 and 148 and a bottom 134 and 150 respectively. The tops 132 and 148 are negatively charged and the bottoms 134 and 150 are positively charged creating an opposite magnetic orientation to the stationary magnet 110. Once in place, the first and the second rotational magnets 130 and 146 experience a repulsive magnetic force from the oppositely magnetically oriented stationary magnet 110.

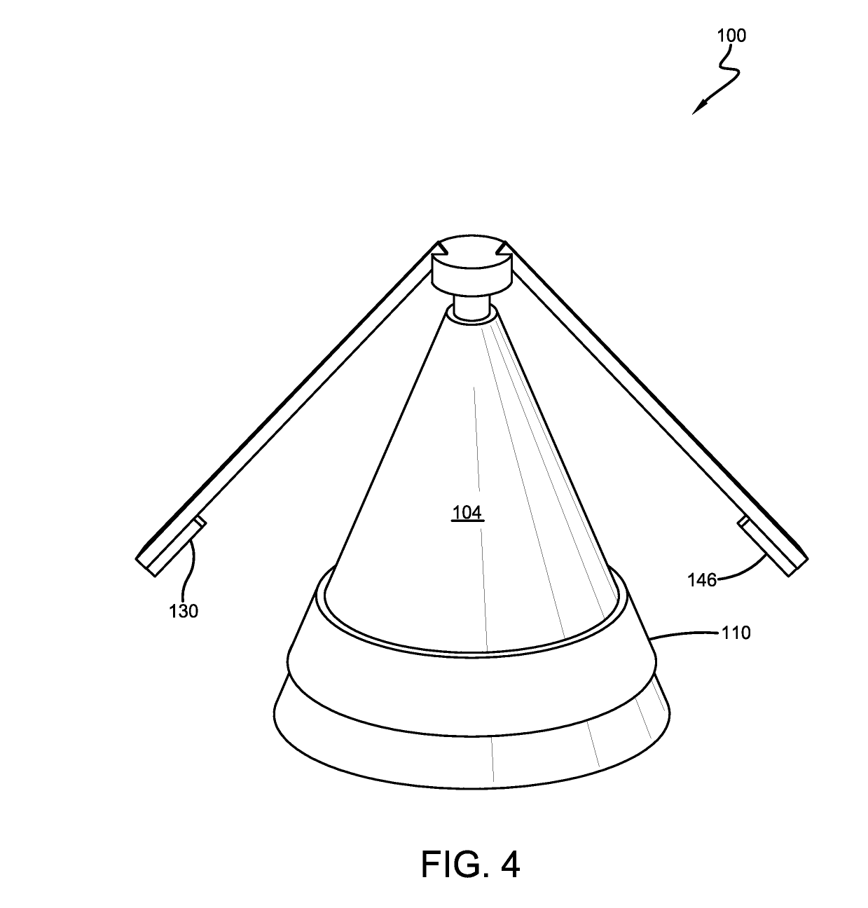

As illustrated in FIGS. 2 and 4, the apex 152 comprises a roller bearing 154 rotatably connected to the shaft 168. As the first and the second arms 120 and 136 spin due to the repulsive magnetic forces, the roller bearing 154 turns the shaft thereby powering the generator 166. The apex 152 may further comprise a hinge element 156. The hinge element 156 allows the first and the second arms 120 and 136 to move between an open position and an engaged position. In the open position illustrated in FIG. 4, the first and the second arms 120 and 136 lift upward approximately up to five inches away from the conical housing 104. In the open position, the repulsive magnetic forces are not strong enough to rotate the first and the second arms 120 and 136 so that the magnetic motion apparatus 100 stops generating electricity.

In the engaged position illustrated in FIG. 3, the first and the second arms 120 and 136 are moved downward toward the conical housing 104 so that the first and the second rotational magnets 130 and 146 are approximately 1/16 inches away from the stationary magnet 110 at a closest point. Once in the engaged position, the repulsive magnetic forces are strong enough to induce the first and the second arms 120 and 136 to spin rotating the shaft 168 to allow the generator 166 to produce electricity.

The hinge element 156 comprises a position locking element 158 for locking the first and the second arms 120 and 136 in to a plurality of positions including the open position 160 and the engaged position 162. As the rotational speed of the first and the second arms 120 and 136 decreases in relation to the distance of the first and the second rotational magnets 130 and 146 from the stationary magnet 110, as the first and the second rotational magnets 130 and 146 extend outward, the rotational speed decreases until it stops at the open position 160. The position locking element 158 may lock the first and the second arms 120 and 136 at a plurality of positions between the open position 160 and the engaged position 162 so that a user may control the output of the generator 166 as desired.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A magnetic motion apparatus for producing an electric current comprising:
a base component comprising a conical housing and a stationary magnet surrounding the conical housing;
a rotational component exterior to the base component comprising a first arm and a second arm connected at an apex, wherein the apex comprises a roller bearing, the first arm comprises a first rotational magnet distal to the apex, and the second arm comprises a second rotational magnet distal to the apex; and
a generator component housed within the conical housing comprising a generator and a shaft, wherein the shaft is rotationally connected to the roller bearing.

2. The magnetic motion apparatus of claim 1, wherein the stationary magnet is a magnetic ring tapered to lay parallel on the conical housing.

3. The magnetic motion apparatus of claim 2, wherein the conical housing comprises a base and a tip and the stationary magnet is located at least one inch above the base.

4. The magnetic motion apparatus of claim 2, wherein the magnetic ring is a single magnet.

5. The magnetic motion apparatus of claim 1, wherein the first and the second arms extend from the apex and run approximately parallel with the conical housing.

6. The magnetic motion apparatus of claim 5, wherein the stationary magnet has a first magnetic orientation, and the first and the second rotational magnets have an opposite magnetic orientation.

7. A magnetic motion apparatus for producing an electric current comprising:
a base component comprising a conical housing and a stationary magnet surrounding the conical housing, wherein the stationary magnet comprises a magnetic ring oriented to produce an upward magnetic force; and
a rotational component exterior to the base component comprising a first arm and a second arm connected at an apex, wherein the apex comprises a hinge element and a roller bearing, the first arm comprises a first rotational magnet distal to the apex and the second arm comprises a second rotational magnet distal to the apex; and
a generator component housed within the conical housing comprising a generator and a shaft, wherein the shaft is rotationally connected to the roller bearing.

8. The magnetic motion apparatus of claim 7, wherein the first and the second rotational magnets are spaced approximately 180 degrees apart around the conical housing.

9. The magnetic motion apparatus of claim 8, wherein the first and the second rotational magnets are in line with the stationary magnet.

10. The magnetic motion apparatus of claim 7, wherein the first and the second rotational magnets extend downward from the first arm and the second arm at an approximately 55 degree angle.

11. The magnetic motion apparatus of claim 7, wherein a spinning motion of the first and the second arms is transferred to the roller bearing to rotate the shaft.

12. The magnetic motion apparatus of claim 7, wherein the first and the second rotational magnets are approximately 1/16 of an inch from the stationary magnet.

13. The magnetic motion apparatus of claim 7, further comprising an electrical cord in electrical communication with the generator for transmitting electrical current.

14. A magnetic motion apparatus for producing an electric current comprising:
a base component comprising a conical housing and a stationary magnet surrounding the conical housing, wherein the stationary magnet comprises a magnetic ring oriented to produce an upward magnetic force; and
a rotational component exterior to the base component comprising a first arm and a second arm connected at an apex, wherein the apex comprises a hinge element movable between an open position and an engaged position and a roller bearing, the first arm comprises a first rotational magnet distal to the apex, and the second arm comprises a second rotational magnet distal to the apex; and
a generator component housed within the conical housing comprising a generator and a shaft, wherein the shaft is rotationally connected to the roller bearing and rotates when the hinge element is in the engaged position but does not rotate when the hinge element is in the open position.

15. The magnetic motion apparatus of claim 14, wherein the hinge element comprises a position locking element.

16. The magnetic motion apparatus of claim 14, wherein the first and the second rotational magnets are approximately 1/16 inches away from the stationary magnet on a first side of the first arm and a first side of the second arm tapering so that the first and the second rotational magnets are approximately ¼ inches away from the stationary magnet on a second side of the first arm and a second side of the second arm.

17. The magnetic motion apparatus of claim 16, wherein the first and the second rotational magnets are approximately 1/16 of an inch from the stationary magnet in the engaged position.

18. The magnetic motion apparatus of claim 14, wherein the first and the second arms extend outward from the apex approximately five inches when in the open position.

19. The magnetic motion apparatus of claim 14, wherein a rotational speed of the first and the second arms decreases as the first and the second arms are extended outward from the apex.

20. The magnetic motion apparatus of claim 19, wherein the hinge element comprises a position locking element capable of locking the hinge at a plurality of positions.
